(19) United States
(12) Patent Application Publication
(10) Pub. No.: US 2020/0038285 A1
(43) Pub. Date: Feb. 6, 2020

(54) MASSAGE TOY HAVING TWO ENERGY SOURCES

(71) Applicant: FUN FACTORY GMBH, Bremen (DE)

(72) Inventor: Dirk BAUER, Bremen (DE)

(73) Assignee: Fun Factory GmbH, Bremen (DE)

(21) Appl. No.: 16/338,395

(22) PCT Filed: Sep. 25, 2017
(86) PCT No.: PCT/EP2017/074208

§ 371 Date: Mar. 29, 2019

(30) Foreign Application Priority Data
Sep. 30, 2016 (DE) 10 2016 118 675.9
Feb. 24, 2017 (DE) 10 2017 103 941.4

(51) Int. Cl. A61H 19/00; A61H 23/02; H01M 10/44; H01M 10/48

(52) U.S. Cl. CPC A61H 19/44; H01M 10/486; H01M 10/44; A61H 23/02

(57) ABSTRACT

A massage toy having a massage body, a drive for generating a vibration for driving the massage toy, a control unit connected to the drive, an operator control for operating the control unit, and a battery compartment implemented in the massage toy for reversibly accepting a non-rechargeable battery or a rechargeable battery, wherein the operator control comprises an electrical contact for connecting to an external charging device for charging the rechargeable battery if the rechargeable battery is received detected in the battery compartment, wherein the massage toy comprises a charging device set up for detecting whether a non-rechargeable battery or a rechargeable battery is received in the battery compartment, wherein the charging device is set up for preventing or stopping charging by means of the external charging device when a non-rechargeable battery is detected in the battery compartment.

### BACKGROUND

### Technical Field

The disclosure relates to a massage toy having a massage body for bringing into contact with body parts to be massaged, a drive for generating a vibration for driving the massage toy, a control unit connected to the drive for controlling the drive, an operator control for operating the control unit, and a battery compartment implemented in the massage toy for reversibly receiving at least one standard-format non-rechargeable battery or one standard-format rechargeable battery for supplying energy to the drive. The invention further relates to a method for charging a massage toy by means of an external charging device.

### Description of the Related Art

Massage toys having a drive, for example also referred to as vibrators, are sufficiently known. For example, one such massage device is known from DE 20 2008 012 653 U1. The massage toy disclosed therein comprises an operator control assembly having a handle and a massage body for bringing into contact with body parts to be massaged or for inserting into bodily orifices. The operator control assembly comprises, in addition to the handle, various operating buttons and a battery compartment for receiving at least two standard format batteries, namely AAA batteries according to ANSI standardization. The corresponding IEC standardization is R03 or LR03 batteries.

The operator control can be screwed to a corresponding counterpart on the massage body, so that said operator control is connected to the massage body in a liquid-tight manner. In order to change the batteries, the operator control must be unscrewed, the batteries removed, and new batteries inserted. In place of non-rechargeable batteries, rechargeable batteries of the same format can be used.

A disadvantage thereof, however, is that an operator must continuously have replacement non-rechargeable or rechargeable batteries available in order to ensure readiness for operation, and must replace said batteries when needed. If the massage toy is brought along while traveling, for example, this increases the weight. Another disadvantage is the environmental load when non-rechargeable batteries are used. Said batteries must be disposed of separately.

Massage toys having an integrated rechargeable battery are also known. One such massage toy, for example, is known from DE 20 2009 008 634 U1. The massage toy disclosed therein in turn comprises a massage body and an operator control, wherein the operator control is permanently and fixedly connected to the massage body. A special rechargeable battery is stored in the interior of the operator control, particularly a lithium-ion or lithium-polymer rechargeable battery, and charging contacts are provided on the operator control for interacting with a special external charging unit or charging cable. The external charging unit can be a charging station in which the massage toy is received in a form-fit manner, such as is known for mobile phones. The external charging unit according to DE 20 2009 008 634 U1 is characterized in that the contacts on the operator control are magnetizable and the external charging unit comprises a magnetized contact, so that charging contact between the external charging unit and the operator control can be established by means of the magnetic force.

A disadvantage of such a massage toy having a permanently integrated rechargeable battery, however, is that in case of wear of the rechargeable battery, for example due to incorrect or improper charging, the rechargeable battery must be replaced, which the user cannot do autonomously. As a rule, it is necessary to send the massage toy to the manufacturer, who then replaces the rechargeable battery with a new one. A further disadvantage is the storage and shipping of such massage toys.

Longer shipping or storage duration can have a negative effect on the permanently installed rechargeable battery. The increased weight negatively affects shipping costs, which in turn has a negative effect on the price for the end consumer.

### BRIEF SUMMARY

The object of the present disclosure is therefore to disclose an improved massage toy, eliminating said disadvantages and allowing flexible use of energy sources.

According to a first consideration of the disclosure, the object named above is achieved for a massage toy of the type named above, in that the operator control comprises an electrical contact for connecting to an external charging device for charging the standard format rechargeable battery, for the case that a standard format rechargeable battery is received in the battery compartment, wherein the charging device is set up for preventing or stopping charging by means of the external charging device in the case that a standard format (non-rechargeable) battery is detected in the battery compartment. The charging unit preferably comprises hardware having software modules to this end. The charging device is preferably set up for detecting whether a standard format non-rechargeable battery or a standard format rechargeable battery is received in the battery compartment, and for preventing or stopping charging by means of the external charging devices in the case that a standard format non-rechargeable battery is detected in the battery compartment.

The battery compartment is implemented according to the disclosure such that both a standard format non-rechargeable battery and a standard format rechargeable battery can be received. The operator control assembly also comprises an electrical contact, by means of which the rechargeable battery received in the massage toy can be charged. Said contact is provided for interacting with a charging cable of an external charging device fitting the massage toy. The massage toy can thus be used both as a “non-rechargeable battery toy” and as a “rechargeable battery toy”, and if a user uses rechargeable batteries, said batteries can be charged by means of the massage toy. It is not necessary to remove the rechargeable batteries from the massage toy and to charge the same using a separate charging station; rather, it is sufficient to connect the massage toy, as is known from other rechargeable battery toys, to the provided charging cable of the external charging device.

The flexibility of the massage toy is thereby increased, because the operator can decide autonomously whether to use conventional, non-rechargeable batteries or rechargeable batteries, and whether to charge the rechargeable batteries by means of the massage toy or externally. If no external charging device for cooperating with the massage toy is available, then it is also possible to replace the (discharged) rechargeable batteries with replacement batteries and thus to restore operational readiness.

The disclosure makes use of the insight that standard format non-rechargeable batteries and standard format rechargeable batteries have the same geometric dimensions and can be interchangeably received in the same battery compartment. The disclosure further makes use of the insight that non-rechargeable standard format batteries must not be charged, for safety reasons, while rechargeable batteries can be recharged. The present disclosure therefore uses the charging unit for detecting which type of energy source, non-rechargeable or rechargeable battery, is in the battery compartment. If it is determined that a rechargeable battery is received in the battery compartment, charging by means of the external charging device is enabled; otherwise, if a non-rechargeable battery is received, then charging is prevented or stopped. If the charging procedure has already begun, said procedure is stopped; otherwise, said procedure is prevented. This improves safety and leads a non-rechargeable battery being unable to be charged unintentionally, which can then lead to the non-rechargeable battery “leaking” or exploding, and thus to substantial risk of injury and destruction of the massage toy.

The operational readiness of the massage toy is thus not only increased by means of the charging unit, but the safety thereof is also influenced to a substantial degree.

A standard form non-rechargeable battery is understood to be a non-rechargeable battery having primary cells, the shape thereof being standardized according to the ANSI and/or IEC standard. In particular, said form comprises AA and AAA and AAAA batteries (ANSI standard) and the corresponding IEC standards. A standard form rechargeable battery is understood to be a rechargeable charge carrier having secondary cells, also having a standardized shape according to ANSI or IEC and corresponding to the shape of a standard form non-rechargeable battery.

The charging unit preferably detects the type of cells, primary or secondary cells, and therefore, whether the battery is a non-rechargeable or rechargeable battery.

According to a first preferred embodiment, the charging unit is set up for determining the nominal voltage of the received non-rechargeable battery or rechargeable battery, and for detecting on the basis of the determined nominal voltage whether a non-rechargeable battery or a rechargeable battery is received in the battery compartment. The nominal voltage of non-rechargeable batteries having primary cells is typically 1.5 V, while the nominal voltage of rechargeable batteries having secondary cells is 1.3 V. This applies at least for the AAA form. By capturing the nominal voltage, it can also be concluded whether the battery is a non-rechargeable or rechargeable battery. This is particularly simple for fully charged (new) batteries. In the present embodiment, protection against unintentional charging of fully charged batteries is provided.

Alternatively to the nominal voltage, it is also possible and preferred to determine the internal resistance of the received charge carrier, that is, the non-rechargeable or rechargeable battery and to detect on the basis thereof whether the battery is a non-rechargeable or rechargeable battery. The internal resistance of a non-rechargeable battery is typically greater than that of a rechargeable battery. It has been shown, however, that the internal resistance also depends on age, charge state, and potentially on the cell temperature. Furthermore, there are no absolute and fixed reference values for an internal resistance by means of which the measured internal resistance can be compared.

A particular difficulty resulting with massage toys of the present type, is that the maximum charging current can be limited. This is the case, for example, if an external charging device having a magnetic contact is used. A magnetic contact is preferred, as said contact does not require any plug contact, which can be hygienically problematic. For such magnetic contacts, the charging current is limited to about 120 mA at 6.5 V, and therefore no strong current impulses used for measurement purposes can be applied to the cells. Furthermore, the computing and storage capacity of the control unit of such a massage toy is limited, so that no extensive analytical procedure can be performed. The battery compartment of the massage toy is also suitable for receiving non-rechargeable or rechargeable batteries connected in series, and the individual contacts cannot be contacted separately for said batteries. Charging is also generally limited to a constant voltage.

Under said conditions, it has been found to be particularly preferable that the charging unit is set up for determining a no-load voltage of the received non-rechargeable battery or rechargeable battery, then applying a predefined load, determining a load voltage of the received non-rechargeable battery or rechargeable battery, and detecting on the basis of a comparison of the no-load voltage and the load voltage whether a non-rechargeable battery or rechargeable battery is received in the battery compartment. This means that a no-load voltage of the received charge carrier, that is, the non-rechargeable or rechargeable battery, is first determined. The no-load voltage is the electrical voltage at the output side when no consumer is connected. A load is then applied, preferably an inductive load, such as a DC motor or a coil actuated by a PWM (pulse width modulation). While the load is applied, the falling voltage is again determined. The no-load voltage and the load voltage are compared. It has been demonstrated that for non-rechargeable batteries comprising primary cells, the difference between the no-load voltage and the load voltage is greater than for rechargeable batteries comprising secondary cells. The absolute value of the voltage difference is typically in the range from 10 mV to 100 mV. It has been found that said difference for rechargeable batteries after applying the load is due to feedback of the inductive load and occurs only in rechargeable batteries having secondary cells. If a mixture of non-rechargeable and rechargeable batteries is received in the battery compartment, the result is again indicative of non-rechargeable batteries. A reliable determination of whether the battery is a non-rechargeable or rechargeable battery is thus thereby achieved.

The load is preferably thereby applied for a brief duration, preferably 10 seconds and less, 7 seconds and less, further preferably 5 seconds and less. It has been found that applying for 5 seconds is sufficient for a reliable determination.

It is further preferable that the load is a complex load. By applying a complex load, not simply drawing a particular amount of power, the procedure of detecting whether the battery is non-rechargeable or rechargeable can be performed particularly reliably. A complex load refers to a load suitable for having an inductive feedback effect.

The drive of the massage toy is preferably used and switched on for this purpose. The drive of the massage toy typically comprises an electric motor, or one or more coils for displacing a magnetic core. It is therefore preferable that the charging unit is set up for causing the control unit to switch on the drive. Alternatively, it is conceivable that the charging unit comprises a dedicated control module set up for controlling the drive. The charging unit is preferably set up for causing the control unit to actuate the drive by means of a pulse-width-modulated signal (PWM signal). It has been found to be practical to use a PWM frequency in the range of 12 kHz. A load current of about 200 mA is sufficient, and said current occurs at a pulse duty factor of about 60%. If even lower currents are used, the clarity of the result may suffer. In this case, unambiguous detecting of whether the battery is rechargeable or non-rechargeable is no longer possible. The load currents are preferably 100 mA and greater. Particularly high currents above 250 mA are equally well suited, but apply a heavy load to discharged cells, possibly leading to misinterpretation, and the cells can be fully discharged, making subsequent charging problematic.

For this reason, the charging unit is preferably further set up for first charging the non-rechargeable or rechargeable battery for 2 minutes or less, preferably 1 minute or less, when a low no-load voltage of the received non-rechargeable or rechargeable battery is determined. Such a brief charging is not dangerous even for a non-rechargeable battery, but prevents the voltage of a rechargeable battery from dropping off too severely, and prevents the rechargeable battery from being deeply discharged due to the measurement method for detecting whether said battery is rechargeable.

In an example, the charging unit comprises a temperature measuring device for measuring the temperature of the received non-rechargeable or rechargeable battery, wherein the charging unit is set up for detecting on the basis of the measured temperature whether a non-rechargeable battery or rechargeable battery is received in the battery compartment. During operation of the massage toy, it is generally insignificant whether the battery is a rechargeable or non-rechargeable battery. Only when charging by means of the charging device connected to the contacts on the operator control assembly is it important for safety reasons to detect whether the battery is non-rechargeable or rechargeable, so that a charging procedure can be optionally prevented or stopped. If a charging procedure is started for a non-rechargeable battery, then the battery will heat up severely. Said temperature of the battery is preferably measured by a temperature measuring device, and if the measured temperature exceeds a predefined threshold temperature, then the charging procedure is stopped. The threshold temperature can be defined at the factory and depends on the type of the battery compartment, as said type determines the type of battery that can be received.

In a further example, the temperature measuring device is set up for measuring a temperature gradient of the non-rechargeable or rechargeable battery, wherein the charging unit is set up for detecting on the basis of the measured temperature gradient whether a non-rechargeable battery or a rechargeable battery is received in the battery compartment. If a charging procedure is started and a non-rechargeable battery is present in the battery compartment, then the temperature of the non-rechargeable battery will rise rapidly, that is, at a relatively high temperature gradient. If said measured temperature gradient exceeds a preset threshold gradient, then the charging procedure is preferably stopped. For said embodiment, it is not necessary that an absolute temperature threshold be exceeded; rather, only the temperature gradient is decisive. A combination of both, a gradient as well as an absolute temperature threshold, is preferably used for stopping the charging procedure.

According to a preferred refinement of the disclosure, the charging unit is set up for detecting that a rechargeable battery received in the battery compartment is deeply discharged, wherein the charging unit prevents or stops charging by means of the external charging device in this case. If a rechargeable battery is deeply discharged, that is, if a cell of the rechargeable battery has a voltage of preferably less than 0.9 V, then recharging the rechargeable battery is associated with hazards the can be avoided by preventing or stopping the charging. In order to check said status, the charging unit preferably comprises a voltage measuring unit for measuring the voltage of the received rechargeable batteries or non-rechargeable batteries and/or the voltage of individual cells.

According to an advantageous refinement of the disclosure, the charging unit is set up for limiting a charging current for charging the rechargeable battery to a value in a range from 60 mA to 120 mA, preferably 60 mA to 100 mA, particularly preferably 75 mA to 90 mA. Most preferable is a value of about 80 mA. Commercially typical standard form rechargeable batteries have cell capacities from 300 mAh to about 1200 mAh. However, the capacity can be measured by a charging unit only by fully charging and subsequently discharging the battery. In order to avoid overcharging the rechargeable batteries, the limited charging current is preferably used for charging. At the preferred value of about 80 mA, a complete charging procedure of a 1200 mAh cell takes about 20 hours, correspondingly about 8 hours for a 600 mAh cell. The charging unit is preferably also set up for measuring the charging voltage, continuously or discretely at predefined intervals. It is further preferable that the charging current is further reduced when the rechargeable battery has been charged to a particular value, such as 80%, 85%, 90%, or 95%.

It is further preferable that the charging unit is set up for limiting a charging voltage to a value in a range from 2 V to 6 V, preferably 2 V to 4 V, particularly preferably approximately 3 V. Said limit applies to the cumulative charging voltage for a pair of rechargeable batteries or non-rechargeable batteries. The charging voltage is thus preferably limited to a value in a range from 1 V to 3V, preferably 1 V to 2 V, particularly preferably approximately a value of 1.5 or 1.45 V per cell. It has been found that limiting the voltage to such a level is largely harmless in case of unintentional charging. That is, as a further safety measure, it is preferable to limit the voltage to said, even when charging, if a rechargeable battery has been detected, in order to increase safety even if a rechargeable battery is incorrectly detected.

To this end, charging unit is preferably set up for measuring the charging voltage and for reducing the charging current to a minimum value when a predefined threshold charging voltage is reached. Said minimum value then serves for maintaining the charge, but further charging and thus overcharging of the rechargeable battery is avoided. If voltage of 95% of the nominal voltage of the rechargeable battery is reached, for example, then the charging voltage is limited to the minimum value.

It is further preferably provided that the charging unit is set up for limiting the charging time to a predefined maximum duration, preferably in a range from 15 to 25 hours. The charging time is preferably limited to 20 hours. It can further be provided that the charging procedure is interrupted when the cell voltage is above about 95% of the nominal voltage for a predefined period of time, thus for example about 1.45 V for a nominal voltage of 1.5 V. Overcharging of the rechargeable battery is also thereby avoided, and unintentional charging of a non-rechargeable battery is avoided.

According to a preferred refinement, wherein the charging unit comprises a rectifier, a voltage regulator, and a diode, the diode is provided for preventing the non-rechargeable battery or rechargeable battery from feeding a voltage into an output of the voltage regulator. The diode is preferably connected between the voltage regulator and a contact on the battery compartment. This means that the voltage regulator feeds the current into the non-rechargeable or rechargeable battery at a regulated voltage via the diode. The voltage regulator is preferably implemented as a so-called LDO, that is, as a voltage regulator having low losses, known as a low-drop regulator. The voltage regulator is implemented for receiving current and voltage from the rectifier and for providing a charging current at a constant voltage to the cells in the battery compartment. One or more resistors can preferably be provided for limiting the current.

According to a further preferred embodiment, the control unit comprises a processor, wherein the processor is implemented so as to be operable at a voltage of a predefined minimum threshold greater than 0, and to be inoperable at a voltage below the minimum threshold, wherein the minimum threshold is 1 volt, preferably 1.5 volts, particularly preferably 1.8 volts. The processor is preferably implemented so as to be operable at a voltage from a predefined minimum threshold greater than 0, and inoperable at a voltage below the minimum threshold, wherein the minimum threshold is 0.5 volts, preferably 0.75 volts, preferably 0.9 volts. The value of 1.8 volts is particularly preferred, because rechargeable batteries having a voltage below 0.9 volts per cell are considered to be deeply discharged, and preferably two non-rechargeable or rechargeable batteries are used for operating the massage toy.

Deeply discharged rechargeable batteries should no longer be used, as said batteries can be damaged in further operation or when charging, and thus can also damage the massage toy. Non-rechargeable batteries providing less than 0.9 volts are in any case discharged and must be replaced. The safety of the massage toy is further improved thereby, because operating the massage toy with deeply discharged rechargeable batteries is prevented.

By limiting the voltage when charging with variable current, charging of non-rechargeable batteries is effectively prevented. If non-rechargeable batteries are received in the battery compartment, and if said batteries are unintentionally charged, then the cell voltage thereof increases relatively quickly due to the beginning of charging, and the current in the cells drops due to the permeated constant voltage. Therefore only a very low current flows through the cells, whereby said cells are not damaged.

According to a further particularly preferred embodiment, the control unit is set up for controlling the drive such that the generated vibration is substantially constant, regardless of a charge state of the non-rechargeable battery or rechargeable battery. For rechargeable batteries and also for non-rechargeable batteries, the voltage drops when discharging, so that the frequency of the generated vibration would decrease. By means of the control unit set up for controlling the drive, preferably by means of an adaptive controller, such that the generated vibration is substantially constant, said decrease is avoided and the operator perceives a constant vibration. The drive is preferably a motor setting an imbalance in rotation, or the drive comprises a coil displacing a magnetic core back and forth. Further drives are conceivable, such as electroactive polymers or the like in particular. The drive preferably comprises a closed-loop control circuit measuring an output vibration and thus providing an input vibration for the motor.

It is further provided that the massage toy comprises a battery holder forming the battery compartment and permanently connected to the massage body, wherein first coupling means are provided on the battery holder and corresponding second coupling means are provided on the operator control, so that the operator control assembly can be reversibly coupled to the battery holder in a form-fit or force-fit manner, wherein the battery compartment is accessible by removing the operator control assembly for replacing the non-rechargeable or rechargeable battery. The battery holder according to the present embodiment is preferably rigid, preferably made of a rigid plastic. Said battery holder is permanently connected to the massage body, said body being typically made of a silicone material. For example, the massage body made of silicone is glued to the battery holder. The drive is further provided in the massage body and can be housed in a motor holder or the like, in turn coupled to the battery holder. The operator control assembly according to the present embodiment can be coupled to the battery holder and reversibly removed from the same, whereby the battery compartment becomes accessible. The operator control assembly thus acts as a cover for the battery compartment, and the operator control assembly must be removed for replacing the batteries. Even if the element is referred to here as a battery holder, it should be understood that said element can also receive rechargeable batteries. The non-rechargeable or rechargeable batteries are thus housed in the massage body and not in the operator control, whereby the weight distribution of the massage toy is more pleasant overall.

The first and second coupling means preferably form a bayonet joint. A bayonet joint is a simple means for producing a form-fit and force-fit connection and provides a defined stop in the closed position. The alignment of the operator control assembly to the massage body is thus always defined.

A seal is preferably provided between the battery holder and the operator control. The seal is preferably implemented as a seal ring. A fluid-tight connection between the operator control assembly and the battery holder is thus achieved, so that the massage toy can also be used under water.

According to a further preferred embodiment, a first battery contact is provided on the battery holder and a second battery contact is provided on the operator control. The first battery contact is preferably disposed on a base or foot segment of the battery holder, that is, at the distal end thereof from the opening of the battery holder. The battery holder is preferably implemented so that the batteries can be inserted along the longitudinal axis thereof. The second contact is disposed on the operator control. If the operator control assembly is removed for changing the battery, the circuit is interrupted and the massage toy cannot be operated. Safety is thereby further improved, as current flow is interrupted when the operator control assembly is opened.

It is further preferable that the charging unit and the control unit are disposed in the operator control. The detecting and control unit can be implemented as hardware and software components, for example, and mounted on a board. The board is then preferably disposed in the operator control. This primarily has advantages for manufacturing, and the operator control assembly can also be more easily replaced in case of a defect.

According to a second consideration, the preceding object of the disclosure is achieved by a method for charging a massage toy, particularly a massage toy according to any one of the embodiments of a massage toy described above according to the first consideration of the disclosure, by means of an external charging device, the massage toy comprising a battery compartment provided for receiving at least one standard form non-rechargeable battery or standard form rechargeable battery, having the steps: detecting by means of a charging unit of the massage toy whether a non-rechargeable battery or a rechargeable battery is received; and if a non-rechargeable battery is detected, preventing or stopping charging by means of the external charging unit. An external charging device here is a charging device for connecting directly to the massage toy. The rechargeable batteries are loaded into the massage toy. Devices requiring that the rechargeable batteries be removed and placed in a separate device for charging are not considered to be an external charging device in the sense of the present application.

It should be understood that the massage toy according to a first consideration of the disclosure and the method according to the second consideration of the disclosure have identical and similar considerations, as are particularly set forth in the dependent claims. In this respect, reference is made in full to the above description of the first consideration of the disclosure for the preferred embodiments and the advantages thereof.

### BRIEF DESCRIPTION OF THE SEVERAL VIEWS OF THE DRAWINGS

The embodiments are described in more detail below by way of reference to the accompanying drawings. Shown are:

FIG. 1 is a perspective view of a massage toy;

FIG. 2 is a perspective view of the massage toy of FIG. 1 having the handle removed;

FIG. 3 is an alternative perspective view of the massage toy of FIG. 2;

FIG. 4 is an exploded view of the massage toy according to FIG. 1;

FIG. 5 is a transverse section view through the massage toy;

FIG. 6 is a vertical section view through the massage toy;

FIG. 7 is a block circuit diagram showing a control unit and a charging unit;

FIG. 8 is an electrical schematic of a charging unit;

FIG. 9 is a flow chart of an exemplary embodiment of a method according to the present disclosure; and

FIG. 10 is a flow chart of an alternative exemplary embodiment of a method according to the present disclosure.

### DETAILED DESCRIPTION

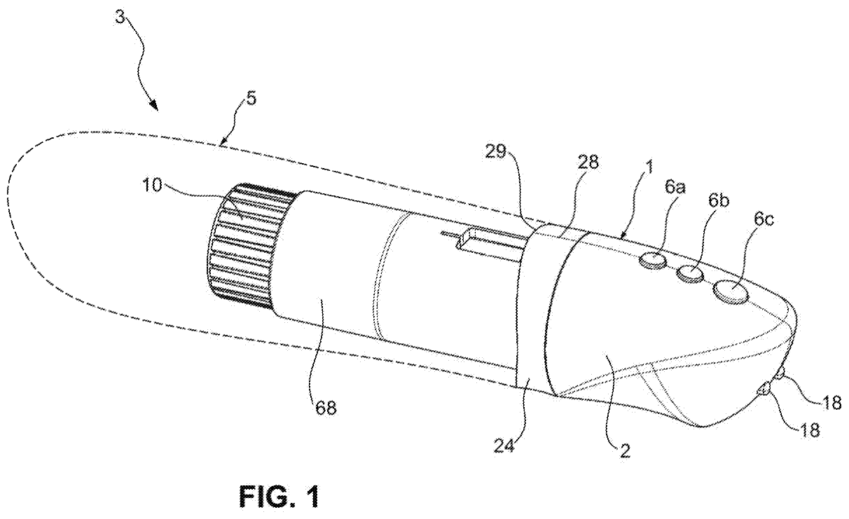

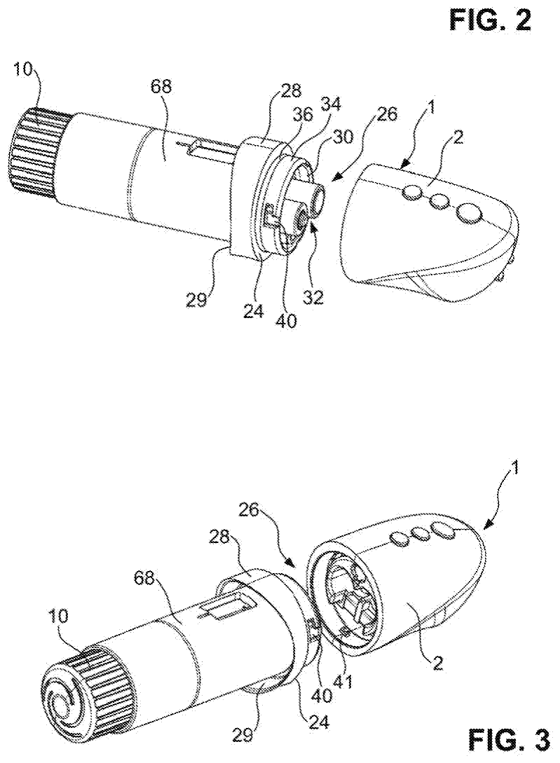

FIG. 1 shows a massage toy 3 having an operator control assembly 1. Three buttons 6a, 6b, 6c for operating the massage toy are provided on the handle 1. The operator control assembly 1 comprises a housing 2 removably attached to a collar 28 of a battery holder 24 (cf. FIG. 2 through 6). The collar 28 comprises an undercut 29 into which a corresponding protrusion of a massage body 5 made of silicone material can be inserted and glued. The massage body 5 is indicated in FIG. 1 only by a dashed line, but is sufficiently known in the prior art. The massage body 5 comprises a drive 10 attached by means of a motor holder 68 on the battery holder 24 in the present embodiment example. Alternatively, a shrink tube can be provided; the motor 10 can also be attached to the battery holder 24 exclusively by means of a shrink tube.

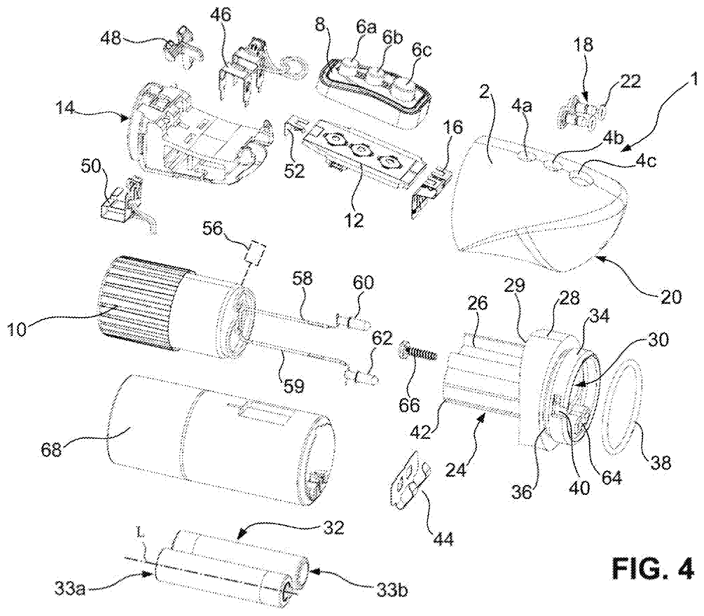

A battery compartment 26 is implemented in the interior (cf. FIGS. 2 and 3) of the operator control assembly 1 and the massage toy 3 and is partially in the battery holder 24 and partially in the handle 1. The operator control assembly 1 is removably attached to the battery holder 24. To this end, the battery holder 24 comprises an annular protrusion 34 on which first form-fit means 40 are implemented. A corresponding form-fit means 41 is provided on an inner side of the operator control assembly 1 and can interact with the form-fit means 40. According to the present embodiment example, the form-fit connection is implemented as a bayonet joint. A groove 36 is further provided on the annular protrusion 34, in which an O-ring 38 (cf. FIG. 4) can be placed. A water-tight connection between the operator control assembly 1 and the battery holder 24 is thus achieved. Liquid can thus not penetrate into the interior of the battery compartment 26.

According to the present embodiment example, two rechargeable batteries 32 are received in the battery compartment 26. It should be understood that the battery compartment 26 can also be implemented differently, for example for three, four, or more non-rechargeable or rechargeable batteries, and also for other sizes.

The interior design of the operator control assembly 1 and of the entire massage toy 3 and in particular the functional principle of the charging unit can be seen in the exploded view in FIG. 4.

FIG. 4 shows an exploded view of the operator control assembly 1 and further elements of the massage toy 3. The operator control assembly 1 is an operator control housing of a massage toy 3 comprising a massage body 5 for bringing into contact with body parts to be massaged (FIG. 1). The operator control assembly 1 comprises a housing 2 serving as a handle for the massage toy. The housing 2 comprises three openings 4a, 4b, 4c in the top side thereof relative to FIG. 4, through which the operating buttons 6a, 6b, 6c of a button mat 8 protrude. The operating button 6c is used for switching the massage toy on and off, and the operating buttons 6a, 6b are used for adjusting various vibration profiles generated by a drive 10.

The button mat 8 interacts with a circuit board 12 comprising a controller, wherein the controller comprises a control unit for controlling the drive 10 and a charging unit described in more detail below. The circuit board 12, together with the button mat 8, is disposed on a circuit board holder 14 made of a plastic material. The button mat 8, circuit board 12, and circuit board holder 14 are inserted in the housing 2 together.

Two charging contact springs 16 are disposed on the circuit board 12 and interact with so-called charging points extending through corresponding openings 20 on the operator control assembly 1. The charging points 18 are sealed liquid-tight by means of seal rings 22. The charging points 18 are spring-loaded by the charging contact springs 16 and can be pressed into the housing 2 to a certain degree. The charging points 18 can be magnetized and are provided for interacting with an external charging device. The charging device (not shown) comprises a grid connection and a charging cable having a magnetic contact at the end thereof corresponding with the charging points 18.

A battery holder 24 is further shown in FIG. 4. The battery holder 24 forms a battery compartment 26 suitable for receiving standard format non-rechargeable batteries 32 and standard format rechargeable batteries. According to the present embodiment example, the battery holder 24 is implemented so that the battery compartment 26 has a size for receiving two AAA non-rechargeable or rechargeable batteries. The battery holder 24 comprises a collar 28 and an access opening 30 through which the non-rechargeable or rechargeable batteries 32 can be inserted along the longitudinal axis L thereof.

A further annular protrusion 34 is provided behind the collar 28 and has a somewhat smaller diameter than the collar 28 and extends axially away from the massage body. A circumferential groove 36 is implemented between the annular protrusion 34 and the collar 28, in which a ring seal 38 can be inserted. Form-fit means 40 are implemented on the annular protrusion 34 and interact with corresponding coupling means on the housing 2. According to the present embodiment example, the coupling means 40 are implemented as a bayonet joint. To this end, two recesses are provided on the annular protrusion 34, while corresponding protrusions are provided on the housing. The operator control assembly 1, including the elements disposed thereon, particularly the button mat 8, the circuit board 12, and the circuit board holder 14 and the charging contact springs 16 can thus be connected to the battery holder 24 in a form-fit manner.

A first battery contact spring 44 is provided on a foot end 42 of the battery holder 24.

The first battery contact spring 44 is provided for making contact with the first end 33a of the non-rechargeable or rechargeable batteries 32 and for producing the circuit between the two non-rechargeable or rechargeable batteries. The corresponding battery contact 46 is provided on the circuit board holder 14 and attached by means of a stopper 48. The battery contact 46 is provided for making contact with the second ends 33 of the non-rechargeable or rechargeable batteries 32 and conducts electrical energy to the circuit board 12. The contact 46 is thus provided in the operator control assembly 1 and if the operator control assembly 1 is removed from the battery holder 24, the electrical contact is interrupted.

First and second motor contacts 50, 52 are further provided on the circuit board holder 14 and the circuit board 12 and are connected to the circuit board 12 and serve for feeding electrical energy to the drive 10.

According to the present embodiment example, the drive 10 is formed from two motors 54, 56 (cf. FIG. 4), wherein drives 10 having only one motor 54 are nevertheless preferred. According to the present embodiment example, the drive 10 comprises two motors 54, 56, because the massage toy comprises a massage body having a main and an ancillary body, a so-called rabbit vibrator. The first motor 54 serves for vibrating the main body, while the second drive 56 serves for driving the rabbit vibrator.

The two motors 54, 56 are connected by means of cables 58, 59 to contact pins 60, 62 extending through corresponding openings 64 (only two of which can be seen in FIG. 4) on the battery holder 24. If the operator control assembly 1 is disposed on the battery holder, the first motor contact 50 makes contact with the contact pins 62 and the second motor contact 52 makes contact with the contact pin 60. The motors 54, 56 can thus be actuated by means of electrical energy via the non-rechargeable or rechargeable batteries 32, controlled by the controller of the circuit board 12.

The drive 10 is coupled to the battery holder 24 by means of a screw 66 and a corresponding shrink tube 68. A charging unit is provided, as mentioned, on the circuit board 12. The charging unit serves for detecting whether non-rechargeable or rechargeable batteries 32 are received in the battery compartment 26 on the battery holder 24. Non-rechargeable batteries 32 cannot be recharged and comprise primary cells, while rechargeable batteries can be recharged and comprise secondary cells. If a non-rechargeable battery 32 is inserted unintentionally, and if a user attempts to charge the same by means of the charging points 12, this would lead to severe heating of the same and ultimately to the battery “leaking” or exploding. In order to prevent this, the charging unit prevents or stops a charging procedure if it is detected that non-rechargeable batteries are received in the battery compartment 26 instead of rechargeable batteries.

According to the present embodiment example, the charging unit comprises a temperature measuring device to this end, measuring a temperature gradient and an absolute temperature of the elements, that is, the rechargeable or non-rechargeable batteries, received in the battery compartment 26. If it is determined that the absolute temperature and the temperature gradient exceed a certain threshold value, then the charging procedure is stopped.

The safety of the massage toy is thereby substantially improved, and it is possible to operate the massage toy both with rechargeable batteries and with non-rechargeable batteries, and to charge the rechargeable batteries in the massage toy. The massage toy according to the present disclosure can thereby be used as a non-rechargeable battery toy and as a rechargeable battery toy, and a user can use both rechargeable batteries and non-rechargeable batteries, and can charge the rechargeable batteries using a charging device inside the massage toy provided particularly for the massage toy.

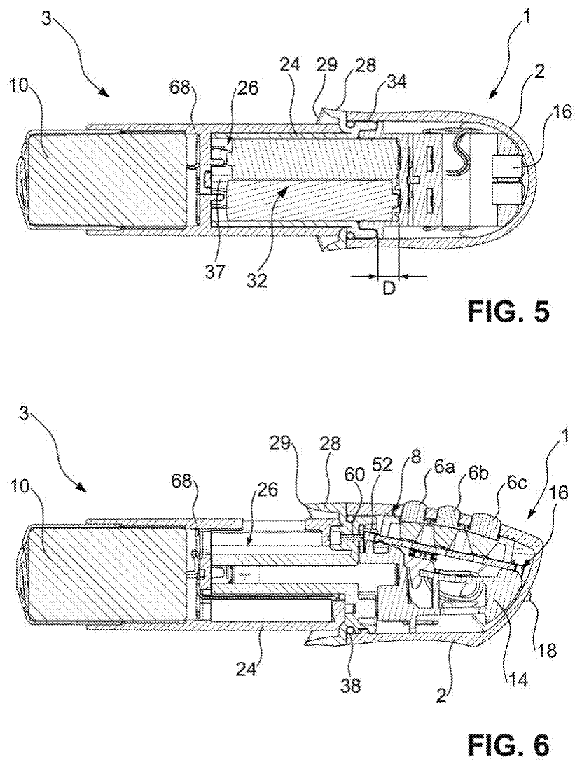

The assembled state can be seen in FIGS. 5 and 6.

The battery holder 24 is implemented so that both rechargeable batteries and conventional non-rechargeable batteries can be received. It has been found in practice, however, that the dimensions of non-rechargeable batteries and rechargeable batteries can deviate, because the uniform standard cannot always be met, including due to the different materials of the charge carriers. It is therefore advantageous if additional clamping means 37 are provided in the battery compartment 26 in order to be able to pretension the non-rechargeable batteries or rechargeable batteries 32. This can occur by axially clamping the non-rechargeable or rechargeable batteries 32 along the longitudinal axis L. As a rule, it is sufficient to press the same against the corresponding contacts with a certain pretension. In addition or alternatively, rubber layers, foam elements, or the like can be provided on the inner wall of the battery holder. As can be seen particularly in FIG. 5, the rechargeable batteries 32 protrude from the battery holder 24 by a distance D, so that said batteries can be gripped by hand and pulled out after removing the operator control assembly 1. If an additional clamping is provided here, then an operator can easily grip the rechargeable batteries 32 at the corresponding end and pull the same out.

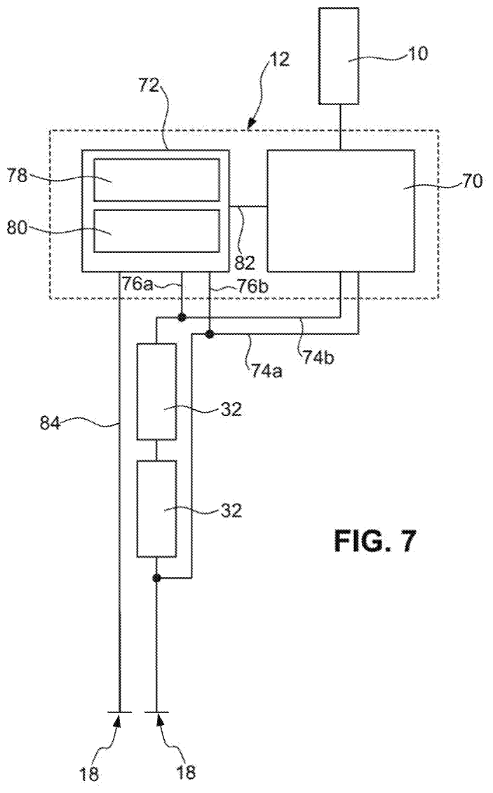

FIG. 7 shows a block diagram showing the control unit 70 and the charging unit 72. Both the control unit 70 and the charging unit 72 are implemented together on the circuit board 12, shown only as a dashed line in FIG. 7. The control unit 70 can be any electronic control circuit, controller, microprocessor, microcontroller or the like. The control unit 70 is connected to the drive 10 in order to provide the same with electrical power and control signals. The control unit 70 is further connected to two charge carriers connected in series, in this case namely two standard format non-rechargeable batteries 32, by means of conductors 74a, 74b.

The charging unit 72 picks up the conductors 74a, 74b by means of two conductors 76a, 76b. The charging unit 72 further comprises a processor 78 and a memory 80, wherein software means are stored in the memory 80.

The charging unit 72 is able to determine the no-load voltage of the batteries 32 via the conductors 76a, 76b. The software means saved in the memory 80 and implemented by the processor 78 cause the charging unit to do so. The software means further cause the no-load voltage to be saved in the memory 80 after determining the same. The charging unit 72 is further set up for applying a predefined load to the batteries 32, in that the charging unit 72 causes the control unit 70, via the connection 82, to actuate the drive 10. The control unit 70 actuates the drive by means of a pulse-width-modulated signal. When the drive 10 is actuated, the charging unit 72 captures a load voltage after about 5 seconds by picking up the voltage by means of the conductors 76a, 76b. Said load voltage is also saved in the memory 80. The charging unit 72 is then implemented for comparing the no-load voltage and the load-voltage saved in the memory 80. The value of the comparison is also saved. Said value is, in turn, compared with predefined threshold values. If the no-load voltage is found to be higher than the load voltage, then the batteries 32 are non-rechargeable. In this case, charging of the batteries 32 is prevented in that the conductor 84 is blocked by the charging unit 72.

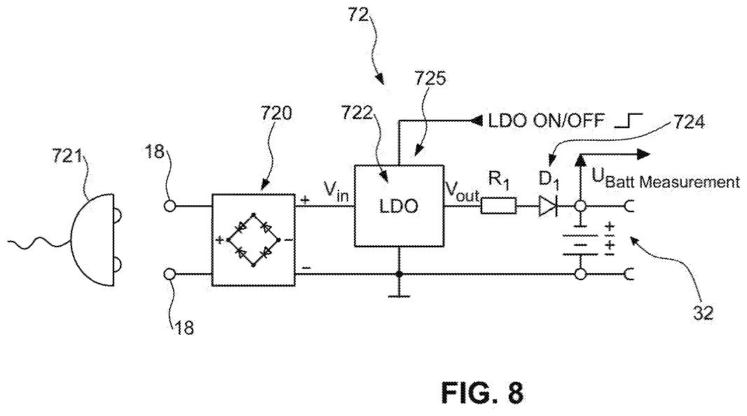

FIG. 8 shows a further block circuit diagram of an alternative embodiment. The charging unit 72 comprises the two charging points 18 for contacting by means of a magnetic plug 721. The magnetic plug 721 comprises two magnetic contacts corresponding to the charging point 18 and is connected to a power supply (not shown). The charging points 18 are connected to a rectifier 720 implemented here as a bridge rectifier. The rectifier 720 prevents a defect from being caused to the charging unit 72 or the control unit 70 in case of reversal of polarity of the magnetic plug 721. The rectifier 720 is connected to a voltage regulator 722, implemented here as an LDO. When the charging points 18 are contacted by the magnetic plug 721 and a voltage is applied to the charging points 18, the voltage regulator 722 is switched on by the control unit 70 (not shown in FIG. 8) by means of a control input 725. The voltage regulator 722 then provides a voltage at a constant value of about 3 volts via a resistor R1 and a diode 724 to non-rechargeable or rechargeable batteries 32, shown here only schematically. This means that 1.5 volts is provided per cell. It should be understood that in the present embodiment example, two cells, that is, two non-rechargeable or rechargeable batteries are received in the corresponding battery compartment. If, however, only one or a different cell or more cells are received, then a different value than 3 volts can be preferable. For example, if three batteries 32 are received, then a value of 4.5 volts is preferable. The value of 1.5 volts corresponds approximately to the value of the nominal voltage of each of the cells. For example, if cells having a nominal voltage of 9 volts are received, then it is preferable to limit the value of the voltage provided by the voltage regulator 722 to 9 volts. It is thereby prevented that non-rechargeable batteries, unable to be recharged, have too high a current applied and are thereby destroyed. If non-rechargeable batteries 32 are received in the battery compartment, and not rechargeable batteries, and if a magnetic plug 721 is then connected, the constant voltage is provided by the voltage regulator 722. Because the voltage corresponds to the nominal voltage of the batteries, and the voltage in the non-rechargeable batteries increases relatively quickly in case of unintentional charging, the difference between the applied voltage and the voltage in each of the cells is relatively small, so that only a relatively low current flows through the cells. A charging procedure is thereby prevented.

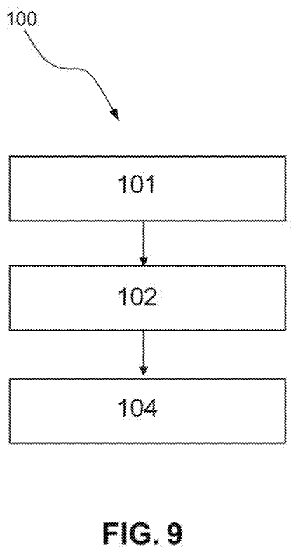

FIG. 9 shows a flow chart of a method 100 according to the disclosure. In a first step 101, the massage toy 3 is connected to an electrical power grid. Step 102 comprises detecting, by means of a charging unit of the massage toy 3, whether a non-rechargeable battery or a rechargeable battery 32 is received in the battery compartment 24. Finally, in step 104, if a non-rechargeable battery is detected, charging 101 is prevented or stopped. It is thereby avoided that non-rechargeable batteries are in fact charged, and thus damage to the massage toy 3 is prevented.

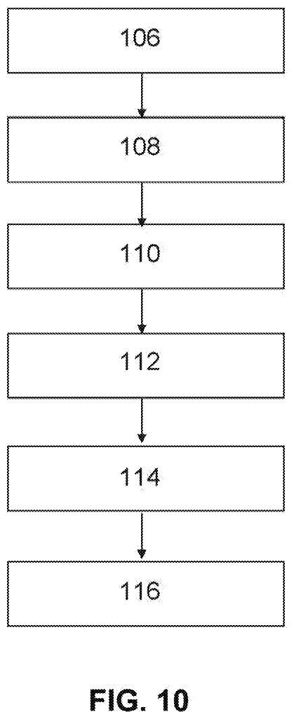

FIG. 10 shows a further flow chart showing greater detail of detecting in step 102. First, in step 106, a no-load voltage of the received non-rechargeable battery or rechargeable battery is determined. In step 108, it is then determined whether the determined no-load voltage is a low no-load voltage. If this is the case, then the non-rechargeable battery or rechargeable battery is then charged for 2 minutes or less, preferably 1 minute or less, at a maximum voltage of 3 V. This is intended to prevent steps 110 and subsequent steps from bringing about a deep discharge of a rechargeable battery. If it is not determined in step 108, however, that the no-load voltage is a low no-load voltage, but rather a normal voltage, then step 110 is directly performed. Step 110 relates to applying a predefined load. The load is preferably a complex load and comprises switching on the drive by means of a pulse-width-modulated signal. The pulse-width-modulated signal preferably has a frequency of 12 kHz, and the load current is preferably about 200 mA. The drive of the massage toy is used to this end. The user is thus also provided with feedback that the massage toy is currently occupied with determining whether a non-rechargeable battery or rechargeable battery is received in the battery compartment.

The predefined load is preferably applied for about 5 seconds. In step 112, a load voltage measured at the non-rechargeable battery or rechargeable battery while the predefined complex load is present is then determined.

In step 114, the no-load voltage and the load voltage are then compared. If it is thereby determined that the difference between the no-load voltage and load voltage is greater than a predefined threshold value, then the battery is a non-rechargeable battery. In the opposite case, if the difference between the no-load voltage and load voltage is less than a predefined threshold value, then the battery is a rechargeable battery. The predefined threshold value is preferably stored in a memory and can be accessed by the charging unit. The charging unit then preferably performs the comparison. This is then detected in step 116. In step 104, the rechargeable battery, if the battery is such, can then be charged.

In view of the above, an exemplary embodiment of a massage toy (3) according to the present disclosure comprises a massage body (5) for bringing into contact with parts of the body to be massaged, a drive (10) for generating a vibration for driving the massage toy, a control unit (70) connected to the drive (10) for controlling the drive (10), an operator control assembly (1) for operating the control unit (70), and a battery compartment (26) implemented in the massage toy for reversibly accepting at least one standard format non-rechargeable battery (32) or a standard format rechargeable battery for supplying energy to the drive (10). The operator control assembly (1) comprises an electrical contact (18) for connecting to an external charging device for charging the standard format rechargeable battery in the case that a standard format rechargeable battery is received in the battery compartment (26), wherein the massage toy comprises a charging device (72), and the charging de-vice is set up for preventing or stopping charging by means of the external charging device in the case that a standard format non-rechargeable battery (32) is detected in the battery compartment.

In a further embodiment, the charging device (72) is set up for detecting whether a standard format non-rechargeable battery (32) or a standard format rechargeable battery is received in the battery compartment (26), and for preventing or stopping charging by means of the external charging devices in the case that a standard format non-rechargeable battery (32) is detected in the battery compartment. In a further embodiment, the charging unit (72) is set up for determining the nominal voltage of the received non-rechargeable battery (32) or re-chargeable battery, and for detecting on the basis of the determined nominal voltage whether a non-rechargeable battery (32) or a rechargeable battery is received in the battery compartment (26). In an alternative embodiment, the charging unit (72) is set up for determining a no-load voltage of the received non-rechargeable battery (32) or re-chargeable battery, then applying a predetermined load, determining a load voltage of the received non-rechargeable battery (32) or rechargeable battery, and based on a comparison between the no-load voltage and the load voltage, detecting whether a non-rechargeable battery (32) or a rechargeable battery is received in the battery compartment (26).

Further, in an embodiment, the predetermined load is applied for a brief duration, preferably 10 seconds and less, further preferably for 7 seconds and less, and most preferably 5 seconds and less. In an embodiment, the predetermined load comprises switching on the drive (10). In an embodiment, the charging unit (72) is set up for causing the control unit (70) to actuate the drive (10) by means of a pulse-width-modulated (PWM) signal. In an embodiment, the charging unit (72) is set up, on determining a low no-load voltage of the received non-rechargeable battery (32) or rechargeable battery, for first charging the non-rechargeable battery (32) or the rechargeable battery for 2 minutes or less, preferably 1 minute or less. In an embodiment, the charging unit (72) comprises a temperature measuring device for measuring the temperature of the received non-rechargeable battery (32) or rechargeable battery, wherein the charging unit (72) is set up for determining whether a non-rechargeable battery (32) or a rechargeable battery is received in the battery compartment (26) on the basis of the measured temperature.

In a further embodiment, the temperature measuring device is set up for measuring a temperature gradient of the non-rechargeable battery (32) or rechargeable battery, wherein the charging unit (72) is set up for detecting, on the basis of the measured temperature gradient, whether a non-rechargeable battery (32) or a rechargeable battery is received in the battery compartment (26). In an embodiment, the charging unit (72) is set up for detecting that a rechargeable battery received in the battery com-partment (26) is deeply discharged and for preventing or stopping charging by means of the external charging device in this case. In an embodiment, the charging unit (72) is set up for limiting a charging current for charging the rechargeable battery to a value in a range from 60 mA to 120 mA, preferably 60 mA to 100 mA, particularly preferably 75 mA to 90 mA. In an embodiment, the charging unit (72) is set up for limiting a charging voltage to a value in a range from 2 V to 6 V, preferably 2 V to 4 V, particularly preferably approximately 3 V. In an embodiment, the charging unit (72) is set up for limiting a charging voltage to a value in a range from 1 V to 3 V, preferably 1 V to 2 V, particularly preferably approximately 1.5 V, preferably 1.45 V per cell.

In still further embodiments, the charging unit (72) is set up for measuring the charging voltage and for reducing the charging current to a minimum value when a predefined threshold charging voltage is reached. In an embodiment, the charging unit (72) is set up for limiting a charging time to a predefined maximum duration, preferably in a range from 15 to 25 hours. In an embodiment, the charging unit (72) comprises a rectifier (720), a voltage regulator (722), and a diode (724), wherein the diode (724) is provided for preventing the non-rechargeable battery or rechargeable battery from feeding a voltage into an output of the voltage regulator (722). In an embodiment, the control unit (70) comprises a processor, wherein the processor is implemented so as to be operable at a voltage of a predefined minimum threshold greater than zero, and to be inoperable at a voltage below the minimum threshold, wherein the minimum threshold is 1 V, preferably 1.5 V, particularly preferably 1.8 V. In an embodiment, the control unit (70) is set up for controlling the drive (10) such that the generated vibration is substantially constant, regardless of a charge state of the non-rechargeable battery (32) or rechargeable battery.

An alternative exemplary embodiment of a device according to the present disclosure includes a battery holder (24) forming the battery compartment (26) and fixedly connected to the massage body, wherein first coupling means (40) are provided on the battery holder (24) and corresponding second coupling means are provided on the operator control assembly (1), so that the operator control (1) can be reversibly coupled to the battery holder (24) in a form-fit or force-fit manner, wherein the battery compartment (26) is accessible by removing the operator control (1) for replacing the non-rechargeable battery (32) or the rechargeable battery.

In an embodiment, the first and second coupling means (40) form a bayonet connection. In an embodiment, a seal (38) is provided between the battery holder (24) and the operator control assembly (1). In an embodiment, a first battery contact (44) is disposed on the battery holder (24) and a second battery contact (46) is disposed on the operator control assembly (1). In an embodiment, the charging unit and the control unit are disposed in the operator control (1).

An exemplary embodiment of a method for charging an electronic device according to the present disclosure, by means of an external charging device, includes the massage toy comprises a battery compartment for receiving at least one standard form non-rechargeable battery or one standard form rechargeable battery, having the steps, detecting by means of a charging unit (72) of the massage toy whether a non-rechargeable battery or a rechargeable battery is received in the battery compartment; and if a battery is detected, preventing or stopping charging by means of the external charging device.

In an embodiment, the method further includes, determining the nominal voltage of the received non-rechargeable battery or the re-chargeable battery, and detecting, on the basis of the determined nominal voltage, whether a non-rechargeable battery or a rechargeable battery is received in the battery compartment. In an embodiment, the method further includes determining (106) a no-load voltage of the received non-rechargeable battery or re-chargeable battery; applying (110) a predefined load; determining (112) a load voltage of the received non-rechargeable battery or recharge-able battery; comparing (114) the determined no-load voltage and the determined load voltage; and detecting (116), on the basis of the comparison, whether a non-rechargeable battery or a rechargeable battery is received in the battery compartment.

In an embodiment, the predetermined load is applied for a brief duration, preferably 10 seconds and less, further preferably for 7 seconds and less, and most preferably 5 seconds and less. In an embodiment, the step of applying the pre-defined load comprises switching on the drive (10). In an embodiment, the drive (10) is actuated by means of a pulse-width-modulated (PWM) signal. In an embodiment, the method further includes determining (108) whether the no-load voltage is a low no-load voltage; and charging the non-rechargeable battery or the rechargeable battery for 2 minutes or less, preferably 1 minute or less. In an embodiment, the method further includes measuring a temperature of the received non-rechargeable battery or the rechargeable battery, and detecting, on the basis of the measured temperature, whether a non-rechargeable battery or a rechargeable battery is received in the battery compartment.

In an embodiment, the method further includes, measuring a temperature gradient of the non-rechargeable battery or rechargeable battery; and detecting, on the basis of the measured temperature gradient, whether a non-rechargeable battery or a rechargeable battery is received in the battery compartment. In an embodiment, the method further includes detecting that a rechargeable battery received in the battery compartment is deeply discharged, and preventing or stopping charging by means of the external charging device. In an embodiment, the method further includes limiting a charging current for charging the rechargeable battery to a value in a range from 60 mA to 120 mA, preferably 60 mA to 100 mA, particularly preferably 75 mA to 90 mA. In an embodiment, the method further includes limiting a charging voltage to a value in a range from 2 V to 6 V, preferably 2 V to 4 V, particularly preferably approximately 3 V. In an embodiment, the method further includes measuring the charging voltage, and reducing the charging current to a minimum value when a predefined threshold charging voltage is reached. In an embodiment, the method further includes limiting a charging time to a predefined maximum duration, preferably in a range from 15 to 25 hours. In an embodiment, the method further includes controlling the drive of the massage toy so that the generated vibration is substantially constant, regardless of a charge state of the non-rechargeable battery or rechargeable battery.

It is to be appreciated that the features of the embodiments described herein, and specifically those described with reference to FIGS. 7-10, can be incorporated into any number of electronic devices.

The various embodiments described above can be combined to provide further embodiments. For example, it is to be appreciated the features of the embodiments described herein, and specifically those described with reference to FIGS. 7-10, can be incorporated into any number of electronic devices. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1.-39. (canceled)

40. A portable device, comprising:
a body;
an electronic control circuit coupled to the body;
an operator control assembly in electronic communication with the electronic control circuit, wherein the operator control assembly has an electrical contact for connecting an external charger;
a compartment in the body in electrical communication with the electronic control circuit for receiving at least one standard format battery or a standard format accumulator; and
a charging unit in electronic communication with the electronic control circuit, the charging unit, in operation:
detects whether the at least one standard format battery or the standard format accumulator is positioned in the compartment and enables charging of the standard format accumulator by the external charger in the event that the standard format accumulator is positioned in the compartment and prevents or stops charging by the external charger in the event that the at least one standard format battery is detected in the compartment.

41. The portable device of claim 40 further comprising:
a drive coupled to the body in electronic communication with the electronic control circuit and the compartment, wherein during operation, the drive provides a vibration to the body.

42. The portable device of claim 40 wherein the charging unit comprises a temperature measuring device for measuring a temperature of the at least one standard format battery or the standard format accumulator, the charging unit, in operation:
determines whether the at least one standard format battery or the standard format accumulator is received in the compartment based on the measured temperature.

43. The portable device of claim 40 wherein the charging unit limits a charging current from the external charger to a value in a range from 60 mA to 100 mA.

44. The portable device of claim 40 wherein the charging unit limits a charging voltage from the external charger to a value in a range from 2 V to 4 V.

45. The portable device of claim 40 wherein the charging unit, in operation:
measures a charging voltage from the external charger and reduces a charging current to a minimum value when a predefined threshold charging voltage is reached.

46. The portable device of claim 40 wherein the charging unit, in operation:
limits a charging time of the external charger to a duration in a range from 15 to 25 hours.

47. The portable device of claim 40 wherein the charging unit further comprises:
a rectifier;
a voltage regulator having an output; and
a diode, wherein the diode prevents the at least one standard format battery or the standard format accumulator from feeding a voltage into the output of the voltage regulator.

48. The portable device of claim 40 wherein the electronic control circuit further comprises a processor, the processor being operable at a voltage greater than a minimum threshold, and to be inoperable at a voltage below the minimum threshold, wherein the minimum threshold is between 1 V and 1.8V.

49. A portable device, comprising:
a body;
an operator control assembly removably coupleable to the body and having a first coupling element; and
a compartment fixedly coupled to the body, the compartment comprising a battery holder including a second coupling element, wherein the first and second coupling elements are removably coupleable through a form fit or force fit, and the battery compartment is accessible by removing the operator control assembly to replace a battery in the battery holder.

50. The device according to claim 49 wherein the form fit or the force fit is a bayonet connection.

51. The device according to claim 49 further comprising:
a seal between the battery holder and the operator control assembly.

52. The device according to claim 49 wherein the operator control assembly includes a first battery contact and the battery holder includes a second battery contact.

53. The portable device according to claim 49 wherein the operator control assembly further comprises:
a electronic control circuit; and
a charging unit in electronic communication with the electronic control circuit.

54. A method for charging a portable device with an external charger, comprising:
providing a compartment in the device, the compartment removably receiving one of a battery or an accumulator;
detecting, by a charging unit whether the battery or the accumulator is positioned in the compartment; and
stopping charging by the external charger if the battery is detected in the compartment.

55. The method of claim 54 further comprising:
determining a nominal voltage of the battery or the accumulator; and
detecting whether the battery or the accumulator is received in the compartment, the detecting including comparing the nominal voltage to a first voltage limit for the battery and a second voltage limit for the accumulator.

56. The method of claim 54 further comprising:
determining a no-load voltage of the battery or the accumulator;
applying a predefined load;
determining a load voltage of the battery or the accumulator;
comparing the determined no-load voltage and the determined load voltage; and
detecting, on the basis of the comparing, whether the battery or accumulator is received in the battery compartment.

57. The method of claim 56 further comprising:
determining whether the no-load voltage is a low no-load voltage; and
charging the battery or the accumulator for 2 minutes or less if the no-load voltage is a low no-load voltage.

58. The method of claim 54 further comprising:
measuring a temperature of the battery or the accumulator; and
detecting, on the basis of the measured temperature, whether the battery or the accumulator battery is received in the compartment.

59. The method of claim 54 further comprising:
limiting a charging voltage of the external charger to a value in a range from 2 V to 6 V; and
limiting a charging current of the external charger to a value in a range from 60 mA to 120 mA.
